(19) United States
(12) Patent Application Publication
(10) Pub. No.: US 2018/0247287 A1
(43) Pub. Date: Aug. 30, 2018

(54) METHODS AND SYSTEMS FOR PERFORMING A MOBILE-TO-BUSINESS ANYWHERE ECOMMERCE TRANSACTION USING A MOBILE DEVICE

(71) Applicant: Omnyway, Inc., Redwood City, CA (US)

(72) Inventors: Ashok Narasimhan, San Francisco, CA (US); Mohammad Khan, San Jose, CA (US); William N. Melton, San Francisco, CA (US)

(21) Appl. No.: 15/753,482

(22) PCT Filed: Aug. 19, 2016
(86) PCT No.: PCT/US2016/047898

§ 371 Date: Feb. 19, 2018

Related U.S. Application Data
(60) Provisional application No. 62/207,367, filed on Aug. 19, 2015.

(51) Int. Cl. G06Q 20/12; G06Q 30/06; G06Q 20/32

(52) U.S. Cl. CPC G06Q 20/12; G06K 7/1417; G06Q 20/3276; G06Q 30/0635

(57) ABSTRACT

According to yet another aspect, the subject matter described herein includes a system for generating and completing a direct M2B ecommerce transaction using a mobile device. The system includes a database for storing and maintaining payment information for mobile users. The system also includes a mobile backend server that receives, from a mobile device of a user, first information about an item or transaction, where the mobile device received the first information from a source physically proximate to the mobile device, and second information about the user, that processes the first and second information to determine transaction information and to generate payment information, and that sends the transaction and payment information to a payment network for processing the ecommerce transaction.

### RELATED APPLICATIONS

This application claims the benefit of provisional patent application Ser. No. 62/207,367, filed Aug. 19, 2015, the disclosure of which is hereby incorporated herein by reference in its entirety.

### TECHNICAL FIELD

This disclosure relates to performing secure financial and non-financial electronic transactions made by consumers. More specifically, it relates to methods and systems for performing a direct, mobile-to-business ecommerce transaction using a mobile device.

### BACKGROUND

Since the advent of credit cards, there has always been the risk that one party in a credit transaction, such as the seller of goods or services, will not receive payment for the received goods or services from the buyer, e.g., that the buyer will default or otherwise refuse to pay. This financial risk has traditionally been borne by the issuing bank. To offset this cost, payment networks such as Visa® and MasterCard® require the acquiring bank, which acts on behalf of the merchant, to pay what is called the “interchange rate” to the issuing bank. The interchange rate was traditionally decided by the payment network. For many years the interchange rate was the source of substantial profits to the payment network, at the cost to the merchants, who had no control over the rate.

When the debit card was introduced, the rationale for imposing the interchange rate became questionable. Debit transactions were successful only if there were sufficient funds in the issuing bank and denied otherwise—so what was the risk? When the “signature debit” card was invented (like a debit card, but did not require entry of a PIN into the point of sale terminal), the question became more pointed: why do the payment networks charge the same interchange rate for a debit transaction (the “debit exchange rate”) as they charge for the much riskier credit transaction (the “credit exchange rate”)?

In addition, for both debit cards and credit cards, interchange rates for “card not present” (CNP) transactions were traditionally higher than interchange rates for “card present” (CP) transactions. Unlike CP transactions, such as swiping a magnetic stripe debit card at a Point Of Sale (POS) terminal, which require actual possession of the card, CNP transactions are more easily spoofed because actual possession of the card is not required. In one type of CNP transaction—an ecommerce transaction—the card information was typically entered into a web page manually. Because possession of an actual card is not mandatory to perform an ecommerce transaction, ecommerce transactions (as well as other CNP transactions, such as “provide the card data to the ecommerce retailer verbally over the phone”) were charged a higher interchange rate.

One way that payment networks distinguish between a CP transaction and a CNP transaction is by using a card security code (CSC), also known as a card verification code (CVC), a card verification value (CVV), a card code verification (CCV), and other acronyms, including some that contain letters other than “C” and “V”. A card having data encoded on a magnetic stripe (commonly referred to as a “magstripe card”) contains two different CSCs: one that is stored within the magnetic stripe (hereinafter referred to as “CSC1”) and another that is typically printed on the back of the card itself (hereinafter referred to as “CSC2”). For Visa™ cards, the CSC value stored within the magnetic stripe is referred to as “CVV” while the CSC value printed on the card is referred to as “CVV2”. MasterCard™ cards call them “CVC” and “CVC2”, respectively.

In a “card present” transaction, the terminal will read the value of CSC1 from the magnetic stripe, but in a “card not present” transaction, the user will provide the value of CSC2. (In legacy systems, there was no CSC2 at all. In these systems, a transaction that included no CSC whatsoever was treated as a CNP transaction.) Because the values of CSC1 and CSC2 are different, the payment network can determine whether the transaction was a CP transaction or a CNP transaction, depending on whether it received the CSC1 value or whether is received the CSC2 value (or no CSC value, in legacy systems).

Smart cards and other payment devices that store payment data electronically rather than on a magnetic stripe, may also provide the electronically stored CSC1 value during a CP transaction and may likewise require the user to manually enter the CSC2 value printed on the smart card during a CNP transaction. Some smart payment devices now send a dynamically-generated CSC1 value, rather than a static CSC1 value, during a CP transaction. The dynamic CSC1 value may be generated by the smart card itself or by another entity. During an ApplePay™ transaction using Visa, for example, Visa sends the account number and the security code (i.e., CSC1) to the user's mobile device, which provides that information to the POS terminal via a near-field communication (NFC) protocol connection. Since the POS terminal receives CSC1 rather than CSC2, the POS terminal will treat the transaction as a “card present” transaction.

For all of these types of payment devices, however, the CSC1 value—whether statically stored on the payment device itself, static but provided by an entity other than he payment device, dynamically generated by the payment device itself, or dynamically generated by another entity and provided to the payment device, will be distinct from the CSC2 value that is provided by the user during a CNP transaction.

In scenarios where a payment device receives the static or dynamic CSC1 value from an entity other than the device itself, the ability of the user to perform a CP transaction critically relies on the receipt of that CSC1 value. Should that CSC1 value be unavailable for any reason—including reasons that may be technical, political, or financial—the user will be unable to perform a CP transaction. In that event, the user will likely be still able to perform a CNP transaction by providing the CSC2 value instead (or no CSC value, for legacy systems).

Since 2010, Federal law in the United States requires that CNP charges for signature debit cards cannot be higher than CP charges. Thus, there is no economic disadvantage to users of signature debit cards to force ecommerce transactions at POS terminals to be handled as CNP transactions rather than CP transactions. There are several advantages, in fact: most magstripe cards in use today have a CSC2 value printed on them, which makes the CSC2 value always available. Accordingly, there is a need to provide methods and systems that can force what would normally be a card-present ecommerce transaction at a physical POS to be treated as a card-not-present ecommerce transaction instead. This is the subject of commonly-owned U.S. Provisional Patent Application Ser. No. 62/165,883, filed May 22, 2015 (herein referred to as “the '883 provisional”), incorporated herein in its entirety.

The advantages of performing an ecommerce transaction as a card-not-present transaction apply not only to transactions performed at a physical POS, but may be applied to create a new type of CNP ecommerce transaction that is performed by a mobile device and that does not require a magstripe reader or other type of physical point of sale terminal, does not require connection to an ecommerce website via a mobile web browser, and in fact does not require interaction with any kind of intelligent device at the point of sale. Instead, the mobile device receives information about the item or transaction from very-low-technology (or even no-technology) sources in situ, such as QR codes, which the mobile device can scan and from which the mobile device can extract enough information to engage in an ecommerce transaction directly with a payment network. In this manner, any surface that can display a QR code can be a point of ecommerce transaction. Such a transaction is referred to herein as a “mobile-to-business anywhere” transaction because it takes place between a mobile device and a payment network without requiring any intervening entity, such as a physical POS terminal, an ecommerce website, etc., using in situ information, such as a QR code, that can be supplied to the mobile device from almost anywhere the mobile device happens to be. The same principles can be applied to perform CP transactions anywhere, as well.

In conventional systems, a merchant typically supports an in-store POS network that receives payment information from POS terminals around the store and provides that information to a payment transaction network, such as the Visa™ or MasterCard™ payment transaction networks. A merchant may also have a web-based ecommerce site, which is typically connected to an ecommerce network owned by the merchant. The ecommerce site receives payment information from web users and provides that information via the ecommerce network to a payment transaction network. Even if the POS network and the ecommerce network communicate payment information to the same payment transaction network, the POS network and the ecommerce networks are quite distinct: for security reasons, at least, the physical POS terminals in the store cannot be accessed via the ecommerce website and vice versa. As a result, a merchant typically has to create and maintain two distinct systems—the POS network and the ecommerce network.

What is needed, therefore, is a mechanism by which a shopper in a physical store can perform an ecommerce transaction directly, without having the overhead of going through a merchant ecommerce website. The transaction could be performed while bypassing the POS network entirely (e.g., going to the payment transaction network directly) or could include some interaction with the POS network (e.g., the POS network could act as the conduit by which the transaction information gets to the payment transaction network).

### SUMMARY

The subject matter disclosed herein includes methods and systems for performing a direct M2B ecommerce transaction using a mobile device. Examples of a mobile device include, but are not limited to, a mobile phone or cell phone, a tablet, pad, laptop, watch, fitness bracelet, or other portable computing device.

In one embodiment, a shopper may use his or her mobile device to purchase an item in a physical store via an ecommerce transaction that bypasses the store's POS network and that also does not use the merchant's ecommerce website. In this embodiment, the mobile device provides information to a mobile backend server that communicates with the payment transaction network directly, e.g., without going through the store's POS network and without going through the merchant's ecommerce site, to perform an ecommerce transaction. In this embodiment, none of the transaction information goes through a potentially insecure POS terminal and is not transmitted over a potentially insecure POS network. In particular, sensitive transaction information is provided only by the mobile backend server via a private and secured connection between the mobile backend server and the payment transaction network. Using this embodiment allows a merchant to have a unified approach to initiating secure ecommerce transactions using the same mechanism for both in-store and web-based shopping.

In another embodiment, the mobile device provides information to a mobile backend server that has a connection into the merchant's POS network, e.g., the mobile backend server appears as another POS terminal on the merchant's POS network, which communicates with the payment transaction network directly or via the mobile backend server. In this embodiment also, none of the transaction information goes through a potentially insecure POS terminal. Non-critical information may be transferred via the POS network to the payment transaction network or the mobile backend server, but in this embodiment also sensitive transaction information is provided by the mobile backend server or the POS network via a private and secured connection between the mobile backend server and the payment transaction network.

According to one aspect, the subject matter described herein includes a method for generating and completing a direct M2B ecommerce transaction using a mobile device. A mobile device associated with a user receives first information about an item or transaction from a source physically proximate to the mobile device, and sends the first information along with information about the user to a mobile backend server for storing and maintaining payment information for mobile users. The mobile backend server processes the received information to determine transaction information and to generate payment information, and sends the transaction and payment information to a payment network for processing the ecommerce transaction. Both card present (CP) and card not present (CNP) transactions are supported. The ecommerce transaction is performed without the need to connect to or otherwise use an ecommerce website, which simplifies the transaction path. In one embodiment, it could be said, instead of the conventional “ecommerce website+ecommerce network” path, a “physical store+ecommerce network” path is used instead. This allows a transaction to occur anywhere in the physical store and in reaction to a transaction involving a physical item, but without incurring the overhead of connection through an ecommerce website. This transaction can occur without the involvement of the physical store's POS terminals and POS network at all. Alternatively, the mobile device and mobile backend server operating together can replace the function of a physical POS terminal, where the mobile backend server communicates directly with the store's POS network as if it were another (e.g., virtual) POS terminal.

According to yet another aspect, the subject matter described herein includes a system for generating and completing a direct M2B ecommerce transaction using a mobile device. The system includes a database for storing and maintaining payment information for mobile users. The system also includes a mobile backend server that receives, from a mobile device of a user, first information about an item or transaction, where the mobile device received the first information from a source physically proximate to the mobile device, and second information about the user, that processes the first and second information to determine transaction information and to generate payment information, and that sends the transaction and payment information to a payment network for processing the ecommerce transaction. In one embodiment, the transaction and payment information is sent to the payment network directly. In an alternative embodiment, the mobile backend server is connected to the merchant's POS network, upon which the mobile backend server appears as yet another POS terminal.

The subject matter described herein may be implemented in hardware, software, firmware, or any combination thereof. As such, the terms “function” or “module” as used herein refer to hardware, software, and/or firmware for implementing the feature being described.

In one exemplary implementation, the subject matter described herein may be implemented using a computer readable medium having stored thereon executable instructions that when executed by the processor of a computer control the computer to perform steps. Exemplary computer readable media suitable for implementing the subject matter described herein include disk memory devices, chip memory devices, programmable logic devices, application specific integrated circuits, and other non-transitory storage media. In one implementation, the computer readable medium may include a memory accessible by a processor of a computer or other like device. The memory may include instructions executable by the processor for implementing any of the methods described herein. In addition, a computer readable medium that implements the subject matter described herein may be located on a single device or computing platform or may be distributed across multiple physical devices and/or computing platforms.

The subject matter described herein allows the user to interact with something tangible, e.g., in a physical store environment, and perform an ecommerce transaction without having to go through an ecommerce website. In one embodiment, the transaction is initiated in the payment transaction network without going through a POS terminal, and, in some embodiments, without using the merchant's POS network, either.

In one scenario, the user could perform an interaction at a POS terminal (attended or unattended), while the user is standing in the aisles, when the user is interacting with digital signage, in-store displays, or printed materials, or when the user is interacting with a sales associate (who may be carrying a smartphone or tablet). In one example, the POS terminal could display a QR code that is read by the user's smartphone; the smartphone sends information to the mobile backend server, which initiates a transaction into an ecommerce payment network using CNP rules instead of CP rules. In another scenario, the smartphone sends the information to the mobile backend server, which connects into the POS network via a secure link to securely provide the transaction information to the POS network, which processes the transaction as usual. In one embodiment, the mobile backend server could attempt to perform the ecommerce transaction to the payment network directly, and if unsuccessful, retry the transaction, this time through the POS network.

### BRIEF DESCRIPTION OF THE DRAWINGS

Embodiments of the subject matter described herein will now be explained with reference to the accompanying drawings, wherein the like reference numerals represent like parts, of which:

FIG. 1 is a block diagram illustrating an exemplary system for generating and completing a direct M2B ecommerce transaction using a mobile device according to an embodiment of the subject matter described herein.

FIG. 2 is a flow chart illustrating an exemplary process for generating and completing a direct M2B ecommerce transaction using a mobile device according to an embodiment of the subject matter described herein;

FIG. 3 is signal messaging diagram illustrating messages communicated among components of an exemplary system for generating and completing a direct M2B ecommerce transaction using a mobile device according to an embodiment of the subject matter described herein; and

FIG. 4 is a block diagram for illustrating an exemplary system for generating and completing a direct M2B ecommerce transaction using a mobile device according to another embodiment of the subject matter described herein.

### DETAILED DESCRIPTION

Methods and systems for performing a “mobile-to-business (M2B) anywhere” ecommerce transaction using a mobile device are provided herein. Unlike a so-called “mobile commerce” or “M-commerce” transaction, in which a mobile device is used in place of a personal computer to connect to a web-based ecommerce site, a M2B anywhere ecommerce transaction takes place between a mobile device and a payment network directly, i.e., without requiring an of these intervening entities, using information about the item or transaction received by the mobile device from sources in situ.

In one embodiment, the mobile device scans a QR code, from which it extracts enough information to engage in an ecommerce transaction directly with a payment network. Both CP and CNP transactions can be supported. Examples of other in situ sources include, but are not limited to: bar codes, which the mobile device can scan; NFC beacons, which transmit data that the mobile device can receive; images of text, which the mobile device can capture and on which it can perform optical character recognition (OCR). The source of the information could actively send the information to the mobile device, or the mobile device could read or detect information passively presented by the source of the information.

The in situ information received can include, but is not limited to, information about the item, information about transaction, and information about the merchant or provider. Such information may include, but is not limited to, the item name, description, SKU number, or other type of description; the item price; the merchant, seller, or provider of the item; the location of the physical item being sold, the service being provided, and/or the point of purchase; the date and time of the transaction; and any other type of information.

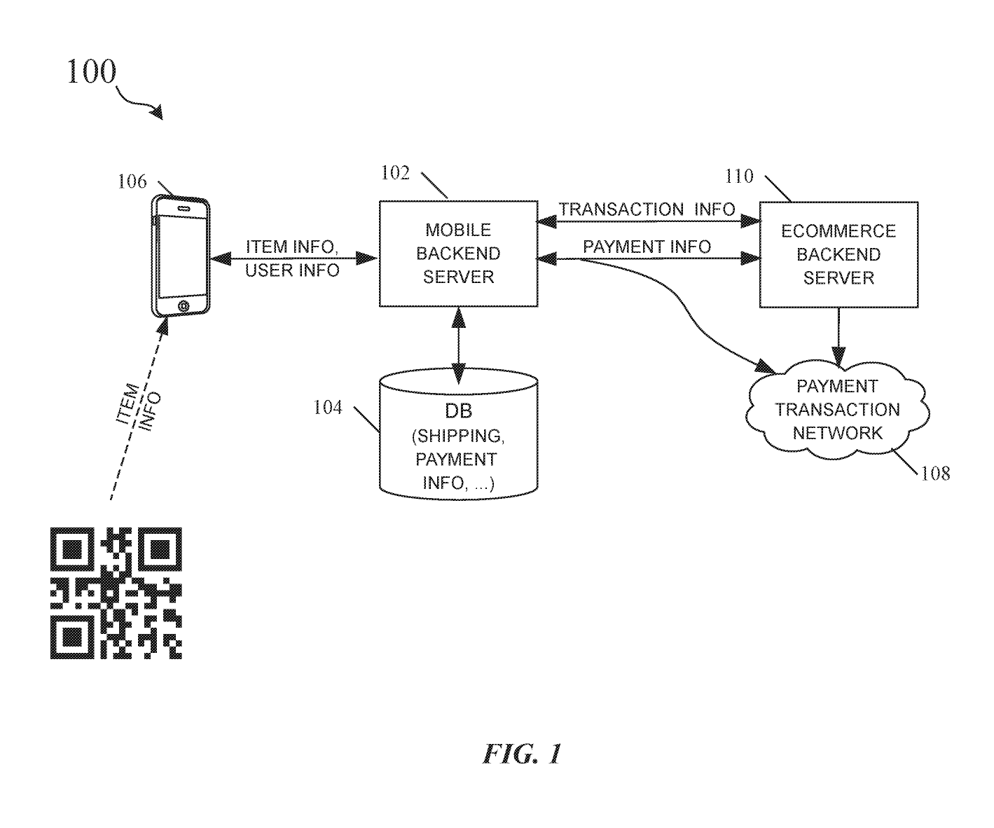

FIG. 1 is a block diagram illustrating an exemplary system for generating and completing a direct M2B ecommerce transaction using a mobile device according to an embodiment of the subject matter described herein. In the embodiment illustrated in FIG. 1, system 100 includes a mobile backend server 102 that communicates with a database 104 database for storing and maintaining payment information for mobile users.

Mobile backend server 102 receives, from a mobile device 106 of a user, information that identifies an item of interest that is the subject of a desired ecommerce transaction (herein referred to as “item information”.) Mobile backend server 102 may also receive information about the user (herein referred to as “user information”.) The mobile backend server 102 may receive information from the mobile device 106 because the mobile device 106 initiates the communication or because the mobile device 106 responds to a request from the mobile backend server 102. Mobile backend server 102 may use the user information to query database 104 to retrieve payment information that is ultimately sent to an entity that performs an ecommerce transaction. In the embodiment illustrated in FIG. 1, that entity is a payment transaction network 108, but other ecommerce transaction entities are also contemplated, including those that perform non-payment ecommerce transactions.

In one embodiment, the item information is provided by a merchant or other provider of goods or services. In the embodiment illustrated in FIG. 1, system 100 also includes an ecommerce backend server 110, which is typically owned or operated by the merchant/provider and which may act as intermediary between mobile backend server 102 and payment transaction network 108. The functions of the components of system 100 will be described in more detail below.

User information may include, but is not limited to, information that identifies the user seeking the transaction, whether or not the user owns mobile device 106 (e.g., in case the user is using a friend's mobile device); information that identifies the mobile device itself; the current location of the user or mobile device; a billing address of the user; a shipping address of the user; a shipping preference of the user; a payment preference of the user; and so on.

Payment information may include, but is not limited to, information that is provided by a traditional magstripe card or smart payment cards, such as primary account number, cardholder name, account holder name, expiration date, CSC data, the name of the issuing bank, billing address, shipping address, etc. In one embodiment, the payment information is tokenized, in which case the payment information may be a token that contains encoded payment information or that contains information that may be redeemed to determine payment information.

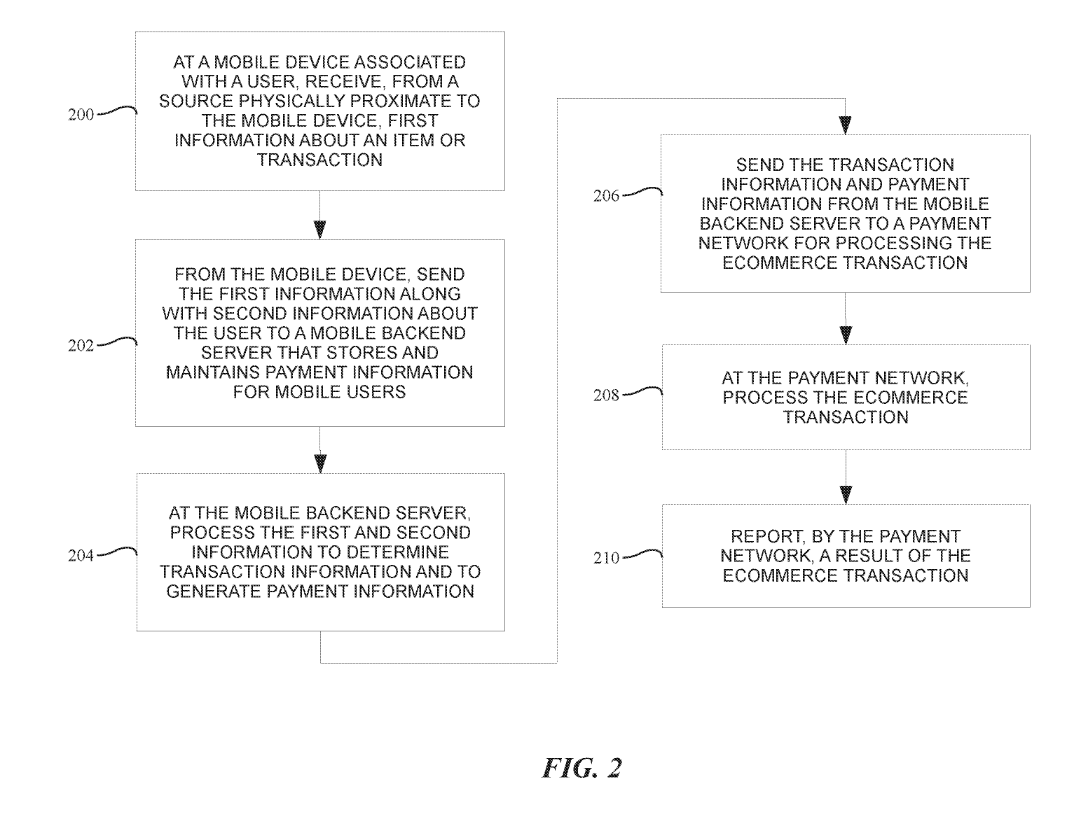

FIG. 2 is a flow chart illustrating an exemplary process for generating and completing a direct M2B ecommerce transaction using a mobile device according to another embodiment of the subject matter described herein. In the embodiment illustrated in FIG. 2, the method includes the following steps, which will be described in reference to the example system 100 in FIG. 1.

At step 200, a mobile device associated with a user receives first information about an item or transaction from a source physically proximate to the mobile device (also referred to as “in situ”.) In the embodiment illustrated in FIG. 1, for example, mobile device 106 may scan a QR code that includes information about an item that the user may want to purchase and have delivered to his or her home.

At step 202, the mobile device sends the first information along with second information about the user to a mobile backend server that stores and maintains payment information for mobile users. In the embodiment illustrated in FIG. 1, for example, mobile device 106 sends item information and user information to mobile backend server 102.

At step 204, the mobile backend server processes the first and second information to determine transaction information and to generate payment information. In the embodiment illustrated in FIG. 1, for example, mobile backend server 102 may communicate with ecommerce backend server 110 to determine transaction information, such as cost of goods including tax and shipping, etc. Mobile backend server 102 may use the user information received from mobile device 106 to query database 104 to get payment information.

At step 206, the mobile backend server sends transaction information and payment information to a payment network for processing the ecommerce transaction. In the embodiment illustrated in FIG. 1, for example, mobile backend server 102 may send payment information to payment transaction network 108 directly or via ecommerce backend server 110.

At step 208, the payment network processes the ecommerce transaction. In the embodiment illustrated in FIG. 1, for example, payment transaction network 108 may perform a card present or card not present ecommerce transaction.

At step 210, the payment network reports the result(s) of the ecommerce transaction. In the embodiment illustrated in FIG. 1, for example, payment transaction network 108 may report whether the ecommerce transaction passed or failed. This report or notification may be sent to mobile device 106, to mobile backend server 102, and/or to ecommerce backend server 110.

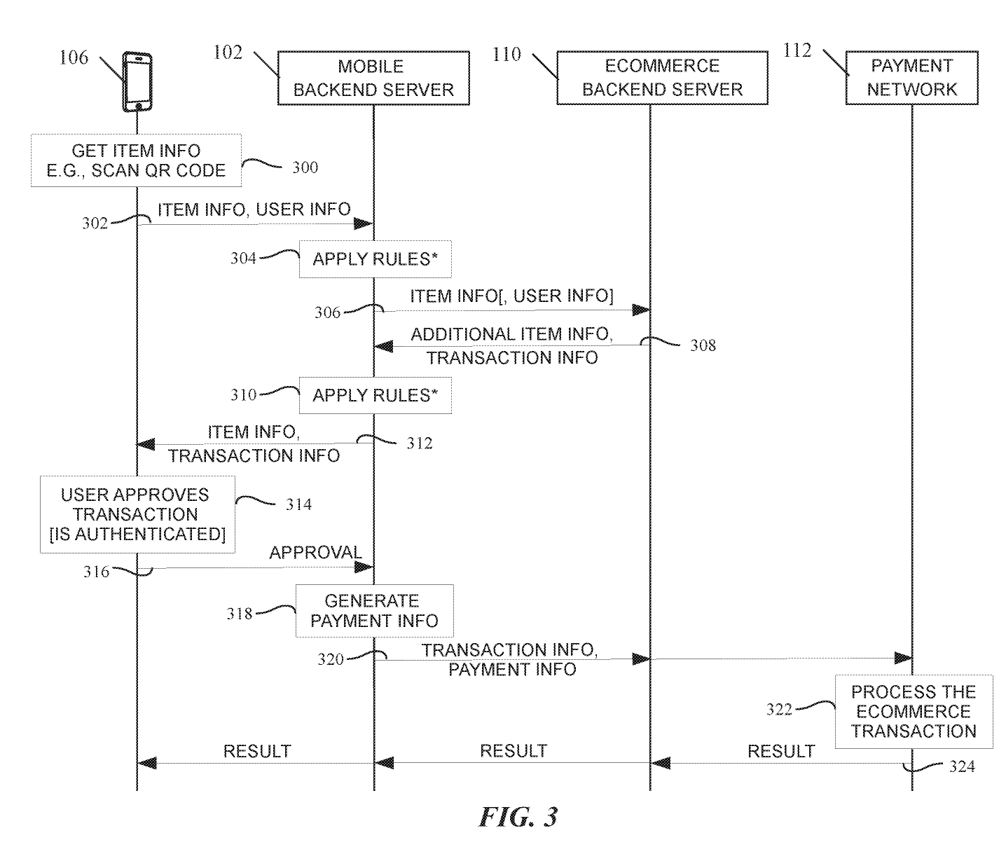

An example operation of system 100 will now be described in more detail using FIG. 3. It will be understood that the phrase “information that identifies <X>” may refer to information that directly identifies the object X, such as the name of a person, the address of a building, the description of an item, etc., and may refer to information that indirectly identifies the object X, such as a key or search term that may be used to identify an entry in a database that contains information about the object, for example.

FIG. 3 is a signal messaging diagram illustrating messages communicated among components of an exemplary system for generating and completing a direct M2B ecommerce transaction using a mobile device according to an embodiment of the subject matter described herein. In the embodiment illustrated in FIG. 3, at block 300, a user of a mobile device 106 gets information about an item. The item of interest may be a product, such as an item on a shelf, an item displayed in an advertisement or print catalog, kiosk, or screen, etc. The item of interest may be a service, such as a manicure, a membership in a health club, a year of lawn care, etc. The item of interest may be a transaction, such as a money transfer, a stock purchase, etc. The item of interest may be, but is not limited to, anything which may be the subject of or related to an ecommerce transaction.

In one example scenario, a user may want to purchase an airplane ticket at an airport ticketing counter or kiosk. Once the user has entered the travel information and selected dates and times for the flight(s), the kiosk may display a QR code, which the user scans with mobile device 106. The QR code may include any type of item information. The item information may be received by mobile device 106 via other means, including, but not limited to, transmission via near-field communication (NFC) or other wireless protocol, such as Wi-Fi, Li-Fi, WiMAX, 802.11, Bluetooth™, beacon, location-based service, cellular, infrared (IR), audio, video, still image, manual entry, bar codes, or other available methods.

In one embodiment, where a user is in a physical store but is performing an ecommerce transaction without the use of a POS network, the POS terminal may nevertheless be a source of item information or other information. Other sources of information may include, but are not limited to: a sales associate or something that the sales associate is carrying, such as a smartphone, tablet, clipboard, etc.; a smart device or other device having a static or dynamic display located within the store (e.g., mounted to a wall or displayed next to the product(s) being sold); the product itself (e.g., a UPC code on an article of clothing); and so on.

In one embodiment, once mobile device 106 has received the item information, mobile device 106 sends the item information to a mobile backend server 102 (message 302). In the embodiment illustrated in FIG. 3, mobile device 106 also includes user information in message 302.

Mobile backend server 102 receives the information and prepares to initiate an ecommerce transaction. In one embodiment, mobile backend server 102 may apply a set of rules that control whether or not a particular transaction should be allowed, based on which user is requesting the transaction, based on what products or services are involved in the transaction, based on whether transaction limits have been exceeded, and so on. These are described in more detail in the '883 provisional mentioned above. In the embodiment illustrated in FIG. 3, at block 304, mobile backend server 102 may apply rules right away to make sure that the item is one that the user is allowed to purchase. For example, an underage user of mobile device 106 may be prohibited from purchasing alcohol. In this scenario, the application of rules at block 304 may result in mobile backend server 102 denying the attempted transaction, in which case the process would stop there. In the embodiment illustrated in FIG. 3, it is assumed that the application of the rules did not result in the transaction being blocked. Rules may be applied by mobile backend server 102 at any point during the process. Likewise, in one embodiment, mobile backend server 102 may not be configured to support or apply any rules.

If the application of rules in block 304 does not result in denial of the transaction (or if block 304 is not performed, i.e., there is no rules check at this point in the process), mobile backend server 102 may use the item information to identify an ecommerce backend server 110 which is associated with the merchant or entity that is offering the item for sale or providing the desired service. In this scenario, mobile backend server 102 may communicate with the identified ecommerce backend server 110 (message 306), e.g., to verify that the item or service is available for purchase and/or delivery. In one embodiment, message 306 may include user information as well, which allows ecommerce backend server 110 to use the user's shipping address or shipping preference to determine shipping costs, to offer discounts or additional deals to the user, and so on. In response, ecommerce backend server 110 may provide to mobile backend server 102 additional item information and/or transaction information (message 308).

Additional item information may include, but is not limited to, confirmation that the item is available, a list of available colors, styles, and/or sizes (e.g., in the case of clothing or footwear), proposed substituted goods or services (e.g., if the desired good or service is unavailable), additional items that the user may want to consider, etc.

Transaction information may include, but is not limited to, the total cost of the item, including tax and/or shipping, an estimated delivery date, the source of the goods or provider of the services, and so on.

In one embodiment, mobile backend server 102 may apply rules to determine whether the transaction should (still) be allowed or otherwise control the behavior of the payment instrument (block 310). In the example illustrated in FIG. 3, the transaction has not been blocked, and therefore mobile backend server 102 sends the item information and transaction information (message 312) to mobile device 106, which may display that information to the user for final approval of the transaction (block 314). In one embodiment, mobile device 106 may require user authentication, such as the entry of a password, pass phrase, PIN, or biometric verification, before or at the same time that the user indicates approval of the transaction at block 314.

In the scenario illustrated in FIG. 3, the user approves the transaction. Mobile device 106 sends notification of that approval to mobile backend server 102 (message 316). Once approval is received, mobile backend server 102 may generate payment information (block 318). In one embodiment, mobile backend server 102 may query database 104 to retrieve the payment information associated with the user of mobile device 106. In one embodiment, mobile backend server 102 may have previously authenticated the combination of mobile user and payment information (or some combination of mobile user, mobile device, and payment information, for example.) This payment information may be selected based on the user's preference or other user info and may be constrained or modified by the application of other rules.

In the embodiment illustrated in FIG. 3, mobile backend server 102 may then forward at least some of the payment information along with the transaction information to a payment network 112 (message 320), which processes the ecommerce transaction (block 322) and reports the result of the transaction (message 324) back to the ecommerce backend server 110, to the mobile backend server 102, and/or to the mobile device 106 (and by extension to the user of the mobile device.) In one embodiment, message 320 is sent directly to payment network 112. In an alternative embodiment, message 320 is sent to payment network 112 via ecommerce backend server 110.

In one embodiment, the ecommerce transaction may be processed as a CP transaction or as a CNP transaction, depending on what information payment network 112 receives from mobile backend server 102. For example, if the payment information generated at block 318 includes a CSC1 value, payment network 112 may process the payment as a CP transaction. Alternatively, if the payment information includes a CSC2 value (or no CSC but a billing address instead), payment network 112 may process the payment as a CNP transaction.

The sequences of messages and actions illustrated in FIG. 3 are illustrative and not limiting. Other embodiments are also within the scope of the subject matter described herein. For example, in one alternative embodiment, mobile backend server 102 may skip the rule application steps 304 and 310 entirely, and may instead apply no rules at all or apply rules at other points in the process.

In another alternative embodiment, the interaction between mobile backend server 102 and ecommerce backend server 110, represented by messages 306 and 308, may occur at a different time in the process or may be skipped entirely.

In yet another alternative embodiment, steps 312, 314, and 316 may be skipped entirely, i.e., user final approval of the transaction is not sought.

In one embodiment, the functions of mobile backend server 102 may be integrated with the functions of ecommerce backend server 110. In these embodiments, system 100 may contain one or the other of mobile backend server 102 and ecommerce backend server 110, but not both. In the embodiment illustrated in FIG. 1, mobile backend server 102 and ecommerce backend server 110 are shown as distinct entities. They may be logically or physically distinct/separate from each other.

The “M2B anywhere” concept has a wide range of applications, including, but not limited to, the following examples and use cases.

Physical (so-called “brick and mortar”) stores with a wide variety of products but limited space sometimes have “virtual aisles”, which may be kiosks or other display areas, that display products for which there is no space in the physical store. A shopper who sees an item of interest displayed on the virtual aisle can use his or her mobile device to scan a QR code that is displayed with or otherwise associated with the image of the item of interest. The mobile device can decode the QR code to extract information about the item or transaction and use the extracted information to perform an ecommerce transaction directly with a payment network. In one embodiment, the ecommerce transaction may include shipping and delivery of the purchased good right to the buyer's home, office, or other location from the warehouse. In one embodiment, a store may display a copy of the most current sales catalog, flyer, or mailer showing goods or services on sale.

The QR code or other in situ information can be printed on a surface, displayed on visual display, such as an LCD price display.

The mobile backend server can perform additional functions, including, but not limited to, providing a discount to a user based on the user's profile, membership in a rewards or loyalty program, use of promotional codes, shipping preferences, etc. The mobile backend server may apply rules that limit what kind of ecommerce transactions are available to the user, the device, the payment instrument to be used, or some combination of the above. For example, a child may scan a QR code to purchase a product but the mobile backend server may block that purchase unless the purchase is authorized by an administrator (e.g., unless the parent allows it.) In this scenario, the parent may get a notification on his or her mobile phone that a child is attempting a purchase, and the ecommerce transaction is not allowed unless the parent authorizes that transaction.

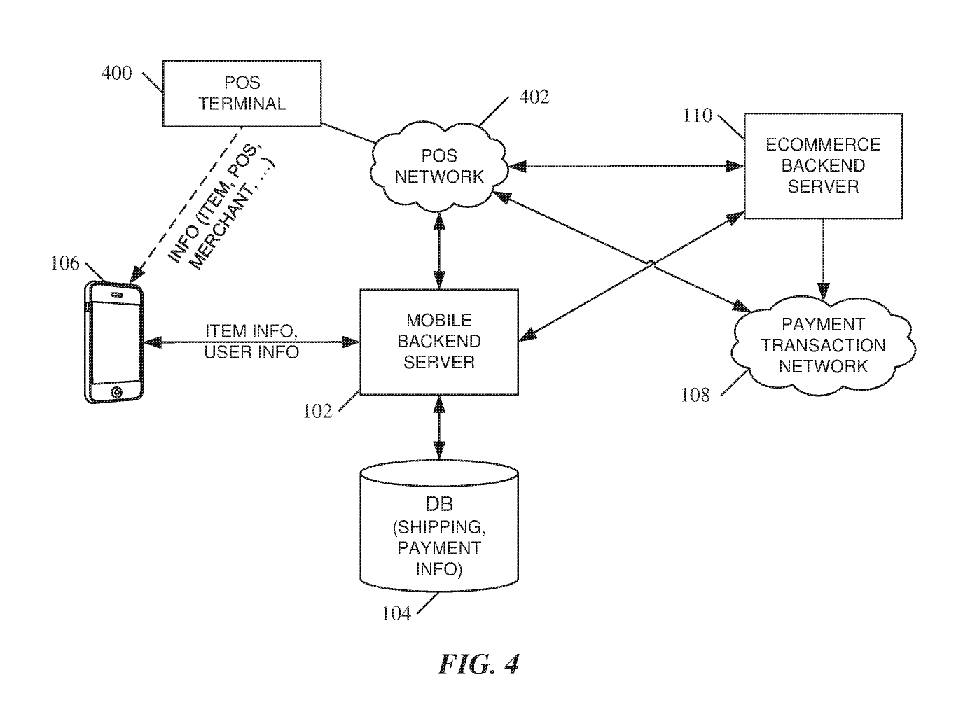

FIG. 4 is a block diagram for illustrating an exemplary system for generating and completing a direct M2B ecommerce transaction using a mobile device according to another embodiment of the subject matter described herein. In the embodiment illustrated in FIG. 4, the system includes a mobile backend server 102, a database 104, a mobile device 106, a payment transaction network 108, and an ecommerce backend server 110, having functions substantially identical to the like-numbered elements of FIG. 1. In the embodiment illustrated in FIG. 4, the system also includes a POS terminal 400 that is connected to a merchant's POS network 402. In the embodiment illustrated in FIG. 4, the POS terminal 400 may provide to the mobile device 106 information about an item, information identifying the POS terminal 400, information identifying the merchant, and so on. The mobile device 106 sends this information to the mobile backend server 102, which communicates with the ecommerce backend server 110 to determine information about the item(s) and/or information about the user (e.g., if the user is a loyalty member, etc.) This transaction information is provided to the mobile backend server 102, which may request final confirmation and/or permission to perform the transaction from the user via the mobile device 106. If approved, the mobile backend server 102 may then retrieve sensitive information (e.g., payment information) and non-sensitive information (e.g., shipping preferences), needed to complete the transaction. At this point, the mobile backend server 102 may provide this information to the POS network 402, e.g., appearing to the POS network 402 as yet another POS terminal. The transaction can continue through the normal POS network 402 as usual. In the embodiment illustrated in FIG. 4, the POS network 402 may communicate directly with the payment transaction network 108 to initiate the ecommerce transaction, or it may go through the ecommerce backend server 110 to do so.

The example embodiments described herein are intended to be illustrative and not limiting. It is important to note that the order of the actions and messages described above are for illustration only and are not intended to be limiting. Furthermore, embodiments having additional steps or fewer steps are also within the scope of the subject matter described herein.

### Embodiment 1

A system for generating and completing a direct M2B ecommerce transaction using a mobile device, the system comprising: a database for storing and maintaining payment information for mobile users; and a mobile backend server that receives, from a mobile device of a user, first information about an item or transaction, where the mobile device received the first information from a source physically proximate to the mobile device, and second information about the user, that processes the first and second information to determine transaction information and to generate payment information, and that sends the transaction and payment information to a payment network for processing the ecommerce transaction.

### Embodiment 2

The system of embodiment 1 wherein receiving the first information includes scanning an image that contains the first information in encoded form and decoding the image to extract the first information.

### Embodiment 3

The system of embodiment 2 wherein the image comprises a QR code image or bar code image.

### Embodiment 4

The system of embodiment 2 wherein the image comprises a text image and wherein decoding the image comprises performing optical character recognition on the text image to extract the first information.

### Embodiment 5

The system of embodiment 1 wherein receiving the first information includes receiving or recording an audio sample that contains the first information encoded as sound and decoding the audio sample to extract the first information.

### Embodiment 6

The system of embodiment 1 wherein receiving the first information includes receiving the first information via a wireless signal produced by the source proximate to the mobile device.

### Embodiment 7

The system of embodiment 6 wherein receiving the first information via a wireless signal produced by the source proximate to the mobile device includes at least one of: communicating using a near field communication (NFC) protocol; receiving the first information from an radio frequency identifier (RFID) chip; and communicating using an infrared (IR) communication protocol.

### Embodiment 8

The system of embodiment 1 wherein sending second information about the user includes sending at least one of: information that identifies the user; information that identifies the mobile device; a current location of the user or mobile device; a billing address of the user; a shipping address of the user; a shipping preference of the user; and a payment preference of the user.

### Embodiment 9

The system of embodiment 1 wherein determining transaction information includes communicating with an ecommerce backend server that provides transaction information.

### Embodiment 10

The system of embodiment 1 wherein the transaction information includes at least one of: confirmation that the item is available; a list of available colors, styles, or sizes of the item; proposed substitute goods or services; additional items that the user may want to consider; the total cost of the item, including tax and/or shipping; an estimated delivery date; and the source of the goods or provider of the services.

### Embodiment 11

The system of embodiment 1 wherein determining transaction information includes applying rules that govern or control the ability of the user to request the transaction or the ability of the payment instrument or financial account to perform the transaction.

### Embodiment 12

The system of embodiment 1 wherein generating payment information includes querying a database for storing and maintaining payment information for mobile users to retrieve the payment information.

### Embodiment 13

The system of embodiment 1 wherein generating payment information includes generating at least one of: a primary account number or information identifying an account; a cardholder name; an expiration date; CSC data; a name of the issuing bank or information identifying a financial institution; a billing address; a shipping address; information identifying the user's membership in a loyalty, rewards, or discount program; and a token that contains or represents one or more of the above.

### Embodiment 14

The system of embodiment 1 wherein sending transaction information and payment information to a payment network includes: sending the transaction and payment information to the payment network directly; or sending the transaction and payment information to the payment network via an ecommerce backend server.

### Embodiment 15

The system of embodiment 1 comprising processing the ecommerce transaction by the payment network.

### Embodiment 16

The system of embodiment 15 comprising reporting the result of the ecommerce transaction back to at least one of mobile backend server, the mobile device, and the user.

### Embodiment 17

The system of embodiment 1 wherein the ecommerce transaction is a card present transaction.

### Embodiment 18

The system of embodiment 1 wherein the ecommerce transaction is a card not present transaction.

### Embodiment 19

The system of embodiment 1 wherein the ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

### Embodiment 20

The system of embodiment 1 wherein determining transaction information includes getting user final approval to perform the transaction and/or authenticating the user.

### Embodiment 21

The system of embodiment 20 wherein authenticating the user by the mobile device includes receiving, at the mobile device, identification information for identifying the user and authentication information for authenticating the identity of the user and using the authentication information to authenticate the identity of the user.

### Embodiment 22

The system of embodiment 21 wherein the information for identifying or authenticating the identity of the user includes at least one of: a name of the user; an address of the user; an identification number associated with the user; biometric information provided by the user; a password, passcode, or personal information number (PIN) of the user; a digital signature of the user, a geo-location of the user, or information from the user's social network.

### Embodiment 23

The system of embodiment 21 wherein authentication of the identity of the user is performed by the mobile device.

### Embodiment 24

The system of embodiment 21 comprising, at the backend mobile server, receiving from the mobile device identification information and authentication information and using the received information to authenticate the user.

### Embodiment 25

The system of embodiment 21 wherein the identification or authentication information is provided by the user or by entity different from the user.

### Embodiment 26

A method for generating and completing a direct M2B ecommerce transaction using a mobile device, the method comprising: at a mobile device associated with a user: receiving, from a source physically proximate to the mobile device, first information about an item or transaction; and sending, to a mobile backend server for storing and maintaining payment information for mobile users, the first information and second information about the user; at the mobile backend server: processing the first and second information to determine transaction information and to generate payment information for an ecommerce transaction; and sending the transaction information and payment information to a payment network for processing the ecommerce transaction.

### Embodiment 27

The method of embodiment 26 wherein receiving the first information includes scanning an image that contains the first information in encoded form and decoding the image to extract the first information.

### Embodiment 28

The method of embodiment 27 wherein the image comprises a QR code image or bar code image.

### Embodiment 29

The method of embodiment 27 wherein the image comprises a text image and wherein decoding the image comprises performing optical character recognition on the text image to extract the first information.

### Embodiment 30

The method of embodiment 26 wherein receiving the first information includes receiving or recording an audio sample that contains the first information encoded as sound and decoding the audio sample to extract the first information.

### Embodiment 31

The method of embodiment 26 wherein receiving the first information includes receiving the first information via a wireless signal produced by the source proximate to the mobile device.

### Embodiment 32

The method of embodiment 31 wherein receiving the first information via a wireless signal produced by the source proximate to the mobile device includes at least one of: communicating using a near field communication (NFC) protocol; receiving the first information from an radio frequency identifier (RFID) chip; and communicating using an infrared (IR) communication protocol.

### Embodiment 33

The method of embodiment 26 wherein sending second information about the user includes sending at least one of: information that identifies the user; information that identifies the mobile device; a current location of the user or mobile device; a billing address of the user; a shipping address of the user; a shipping preference of the user; and a payment preference of the user.

### Embodiment 34

The method of embodiment 26 wherein determining transaction information includes communicating with an ecommerce backend server that provides transaction information.

### Embodiment 35

The method of embodiment 26 wherein the transaction information includes at least one of: confirmation that the item is available; a list of available colors, styles, or sizes of the item; proposed substitute goods or services; additional items that the user may want to consider; the total cost of the item, including tax and/or shipping; an estimated delivery date; and the source of the goods or provider of the services.

### Embodiment 36

The method of embodiment 26 wherein determining transaction information includes applying rules that govern or control the ability of the user to request the transaction or the ability of the payment instrument or financial account to perform the transaction.

### Embodiment 37

The method of embodiment 26 wherein generating payment information includes querying a database for storing and maintaining payment information for mobile users to retrieve the payment information.

### Embodiment 38

The method of embodiment 26 wherein generating payment information includes generating at least one of: a primary account number or information identifying an account; a cardholder name; an expiration date; CSC data; a name of the issuing bank or information identifying a financial institution; a billing address; a shipping address; information identifying the user's membership in a loyalty, rewards, or discount program; and a token that contains or represents one or more of the above.

### Embodiment 39

The method of embodiment 26 wherein sending transaction information and payment information to a payment network includes: sending the transaction and payment information to the payment network directly; or sending the transaction and payment information to the payment network via an ecommerce backend server.

### Embodiment 40

The method of embodiment 26 comprising processing the ecommerce transaction by the payment network.

### Embodiment 41

The method of embodiment 40 comprising reporting the result of the ecommerce transaction back to at least one of mobile backend server, the mobile device, and the user.

### Embodiment 42

The method of embodiment 26 wherein the ecommerce transaction is a card present transaction.

### Embodiment 43

The method of embodiment 26 wherein the ecommerce transaction is a card not present transaction.

### Embodiment 44

The method of embodiment 26 wherein the ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

### Embodiment 45

The method of embodiment 26 wherein determining transaction information includes getting user final approval to perform the transaction and/or authenticating the user.

### Embodiment 46

The method of embodiment 45 wherein authenticating the user by the mobile device includes receiving, at the mobile device, identification information for identifying the user and authentication information for authenticating the identity of the user and using the authentication information to authenticate the identity of the user.

### Embodiment 47

The method of embodiment 46 wherein the information for identifying or authenticating the identity of the user includes at least one of: a name of the user; an address of the user; an identification number associated with the user; biometric information provided by the user; a password, passcode, or personal information number (PIN) of the user; a digital signature of the user, a geo-location of the user, or information from the user's social network.

### Embodiment 48

The method of embodiment 46 wherein authentication of the identity of the user is performed by the mobile device.

### Embodiment 49

The method of embodiment 46 comprising, at the backend mobile server, receiving from the mobile device identification information and authentication information and using the received information to authenticate the user.

### Embodiment 50

The method of embodiment 46 wherein the identification or authentication information is provided by the user or by entity different from the user.

### Embodiment 51

A non-transitory computer readable medium having stored thereon executable instructions that when executed by the processor of a computer control the computer to perform steps comprising: at a mobile device associated with a user: receiving, from a source physically proximate to the mobile device, first information about an item or transaction; and sending, to a mobile backend server for storing and maintaining payment information for mobile users, the first information and second information about the user; at the mobile backend server: processing the first and second information to determine transaction information and to generate payment information for an ecommerce transaction; and sending the transaction information and payment information to a payment network for processing the ecommerce transaction.

1. A system for generating and completing a direct M2B ecommerce transaction using a mobile device, the system comprising:
a database for storing and maintaining payment information for mobile users; and
a mobile backend server that:
receives, from a mobile device of a user, first information about an item or transaction and second information about the user, wherein the mobile device receives the first information from a source physically proximate to the mobile device, wherein the first information and the second information are received in any order;
processes the first and second information to determine transaction information and to generate payment information; and
sends the transaction and payment information to a payment network for processing the ecommerce transaction without going through an ecommerce website.

2. The system of claim 1 wherein the mobile device receives the first information by:
scanning an image that contains the first information in encoded form and decoding the image to extract the first information;
receiving or recording an audio sample that contains the first information encoded as sound and decoding the audio sample to extract the first information; and/or
receiving the first information via a wireless signal produced by the source proximate to the mobile device.

3. The system of claim 2 wherein the mobile device receives the first information by scanning an image that contains the first information in encoded form and decoding the image to extract the first information and wherein decoding the image to extract the first information comprises decoding a QR code image, decoding a bar code image, and/or performing optical character recognition on a text image to extract the first information.

4. (canceled)

5. (canceled)

6. The system of claim 1 wherein the second information about the user includes at least one of: information that identifies the user; information that identifies the mobile device;
a current location of the user or mobile device; a billing address of the user; a shipping address of the user; a shipping preference of the user; and a payment preference of the user.

7. The system of claim 1 wherein the transaction information includes at least one of: confirmation that the item is available; a list of available colors, styles, or sizes of the item; proposed substitute goods or services; additional items that the user may want to consider;
the total cost of the item, including tax and/or shipping; an estimated delivery date; and the source of the goods or provider of the services.

8. The system of claim 1 wherein the mobile backend server generates payment information by querying a database for storing and maintaining payment information for mobile users to retrieve the payment information.

9. (canceled)

10. The system of claim 1 wherein the ecommerce transaction comprises at least one of: a card present transaction; a card not present transaction; a payment or purchase; a credit transaction; a debit transaction; a deposit; a withdrawal; a money transfer; a transaction involving a loyalty program; a transaction involving a rewards program; and a transaction involving a diet, health, or fitness program.

11. The system of claim 1 wherein determining transaction information includes getting user final approval to perform the transaction and/or authenticating the user wherein authenticating the user is performed by the mobile device and/or the mobile backend server.

12. (canceled)

13. A method for generating and completing a direct M2B ecommerce transaction using a mobile device, the method comprising:
at a mobile device associated with a user:
receiving, from a source physically proximate to the mobile device, first information about an item or transaction; and
sending, to a mobile backend server for storing and maintaining payment information for mobile users, the first information and second information about the user; and
at the mobile backend server:
processing the first and second information to determine transaction information and to generate payment information for an ecommerce transaction; and
sending the transaction information and payment information to a payment network for processing the ecommerce transaction without going through an ecommerce website.

14. The method of claim 13 wherein receiving the first information includes:
scanning an image that contains the first information in encoded form and decoding the image to extract the first information;
receiving or recording an audio sample that contains the first information encoded as sound and decoding the audio sample to extract the first information; and/or
receiving the first information via a wireless signal produced by the source proximate to the mobile device.

15. The method of claim 14 wherein receiving the first information includes scanning an image that contains the first information in encoded form and decoding the image to extract the first information and wherein decoding the image to extract the first information comprises decoding a QR code image, decoding a bar code image, and/or performing optical character recognition on a text image to extract the first information.

16-18. (canceled)

19. The method of claim 13 wherein sending second information about the user includes sending at least one of: information that identifies the user; information that identifies the mobile device; a current location of the user or mobile device; a billing address of the user; a shipping address of the user; a shipping preference of the user; and a payment preference of the user.

20. The method of claim 13 wherein determining transaction information includes communicating with an ecommerce backend server that provides transaction information.

21. The method of claim 13 wherein the transaction information includes at least one of: confirmation that the item is available; a list of available colors, styles, or sizes of the item; proposed substitute goods or services; additional items that the user may want to consider;
the total cost of the item, including tax and/or shipping; an estimated delivery date; and the source of the goods or provider of the services.

22. The method of claim 13 wherein generating payment information includes querying a database for storing and maintaining payment information for mobile users to retrieve the payment information to retrieve at least one of: a primary account number or information identifying an account; a cardholder name; an expiration date; CSC data; a name of the issuing bank or information identifying a financial institution; a billing address; a shipping address; information identifying the user's membership in a loyalty, rewards, or discount program; and a token that contains or represents one or more of the above.

23. (canceled)

24. (canceled)

25. The method of claim 13 wherein the ecommerce transaction comprises at least one of: a card present transaction; a card not present transaction; a payment or purchase; a credit transaction; a debit transaction; a deposit; a withdrawal; a money transfer; a transaction involving a loyalty program; a transaction involving a rewards program; and a transaction involving a diet, health, or fitness program.

26. The method of claim 13 wherein determining transaction information includes getting user final approval to perform the transaction and/or authenticating the user, wherein authentication of the identity of the user is performed by the mobile device and/or the mobile backend server.

27. The method of claim 26 wherein authenticating the user by the mobile device includes receiving, at the mobile device, identification information for identifying the user and authentication information for authenticating the identity of the user and using the authentication information to authenticate the identity of the user.

28. The method of claim 27 wherein the information for identifying or authenticating the identity of the user includes at least one of: a name of the user; an address of the user; an identification number associated with the user; biometric information provided by the user; a password, passcode, or personal information number (PIN) of the user; a digital signature of the user, a geo-location of the user, or information from the user's social network.

29. (canceled)

30. A non-transitory computer readable medium having stored thereon executable instructions that when executed by the processor of a computer control the computer to perform steps comprising:
at a mobile device associated with a user:
receiving, from a source physically proximate to the mobile device, first information about an item or transaction; and
sending, to a mobile backend server for storing and maintaining payment information for mobile users, the first information and second information about the user; and
at the mobile backend server:
processing the first and second information to determine transaction information and to generate payment information for an ecommerce transaction; and
sending the transaction information and payment information to a payment network for processing the ecommerce transaction without going through an ecommerce website.
